(19) United States
(12) Patent Application Publication
(10) Pub. No.: US 2004/0130643 A1
(43) Pub. Date: Jul. 8, 2004

(54) Camera capable of using in the portable information appliance products

(76) Inventors: Chao Sheng Chang, Hsinchu City (TW); Yuan Kang Chen, Hsinchu City (TW); Min Hsiung Yeh, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/337,331

(22) Filed: Jan. 7, 2003

(51) Int. Cl. H04N 5/222

(52) U.S. Cl. 348/333.01

(57) ABSTRACT

A camera capable of using in the portable information appliance products is disclosed, including a camera body and a lens provided thereon. A view-finding mirror is placed on the same surface as the lens, and the view-finding mirror is a protrusion processed with glossing so that through the view-finding mirror, the object to be photographed can be viewed. The camera has a function of supporting focusing, and the image of the object to be photographed can be easily captured as well as a self-portrait can be easily taken. Furthermore, the camera can be practically applicable to portable information appliance products, and it has a stylish shape.

### BACKGROUND OF THE INVENTION

1. Field of the Invention

The present invention relates to a camera capable of using in the portable information appliance products and, more particularly, to an improvement of a camera capable of using in the portable information appliance products, which can be used to take a self-portrait easily.

2. Description of the Related Art

The functions of digital cameras are becoming more powerful, whereas the prices of them are decreasing; therefore, a bull market for the products can be anticipated in the future. At present, digital cameras are further used in the portable information appliance products, such as mobile phones, Personal Digital Assistant (PDA), Palm and so on, which are capable of snapping and sharing pictures of impromptu moments. These products are able to transmit images, texts, and sounds, which also means that the conventional limitation in telecommunication has been broken through. Instead, a multimedia messaging service of advanced telecommunication techniques is provided, and because of that, the IA Album is becoming a fashion in telecommunication.

The structure of a general camera, either it is a conventional or a digital, or it is a compact or a single-lens, it must include four basic components: a lens, an aperture, a shutter, and a viewfinder. However, as shown in FIG. 1, a conventional camera 10 is used in the portable information appliance products, because the camera 10 has to be used in a mobile phone 14 shown in FIG. 2, or in other portable information appliance products, the structure of the camera 10 must be smaller and simpler than a general camera. Therefore, mostly the camera 10 is designed to have a lens 12 only rather than have a viewfinder besides the lens 12, as what is designed in a general camera. As a result, it will not be easy to take a self-portrait because there is no coordinate to be referenced or a real object image to assist the photographer in taking the photograph. Consequently, it will be difficult to take a full image, and the image being captured may appear to be fragmentary if the angle for capturing the image is shifted. Therefore, the angle might have to be readjusted repeatedly in order to get a full picture, and a lot of time might be taken before a satisfactory full view can be obtained.

To solve the above problems, the present invention provides an improvement of a camera capable of using in the portable information appliance products.

### SUMMARY OF THE INVENTION

The object of the present invention is to provide a camera capable of using in the portable information appliance products, wherein a view-finding mirror is added to the design to support the focusing function so that a full image of the desired object can be captured easily, and a self-portrait can be easily taken as well.

Another object of the present invention is to provide a camera capable of using in the portable information appliance products, which has features of being practically applicable, easy to be used, and simple to be manipulated, as well as has a stylish shape.

In order to achieve the foregoing objects, the present invention includes a camera body that is used in the portable information appliance products, which has a lens and a view-finding mirror provided thereon. The view-finding mirror is located on the same surface as the lens, and it is a gloss protrusion, for viewing the object to be photographed.

The objects and technical contents of the present invention will be better understood by the description of the following embodiment with reference to the drawings.

### BRIEF DESCRIPTION OF THE DRAWINGS

FIG. 1 is a schematic diagram showing a conventional camera capable of using in the portable information appliance products.

FIG. 2 is a schematic diagram showing FIG. 1 used in mobile phone.

FIG. 3 is a schematic diagram showing the structure of the present invention.

FIG. 4 is a front view of the present invention.

FIG. 5A and FIG. 5B are schematic diagrams showing the present invention used in a mobile phone.

FIG. 6A and FIG. 6B are schematic diagrams showing the present invention used in a PDA.

FIG. 7A and FIG. 7B are schematic diagrams in order to find a view according to the present invention.

FIG. 8A and FIG. 8B are schematic diagrams in order to find another view according to the present invention.

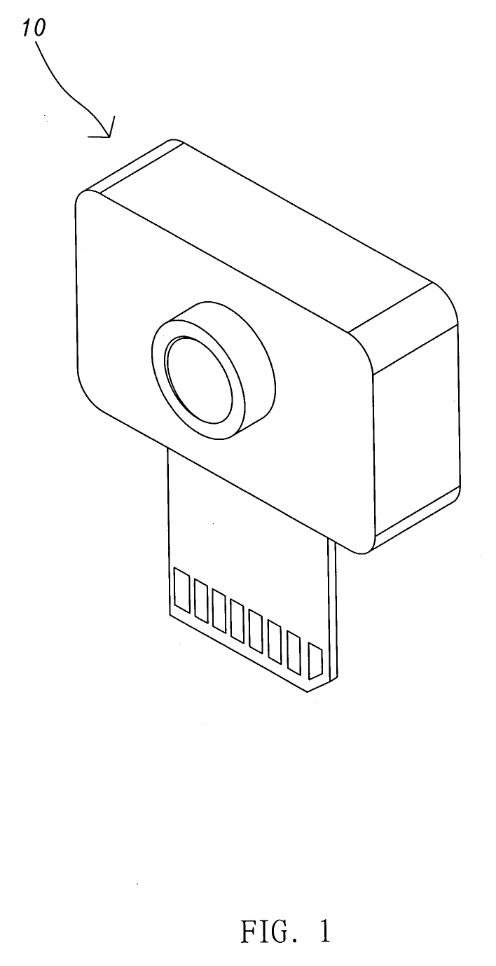

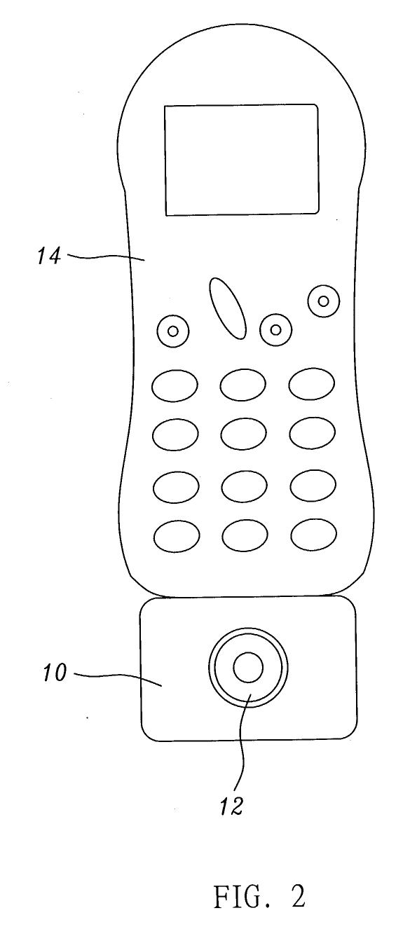

### DESCRIPTION OF THE PREFERRED EMBODIMENTS

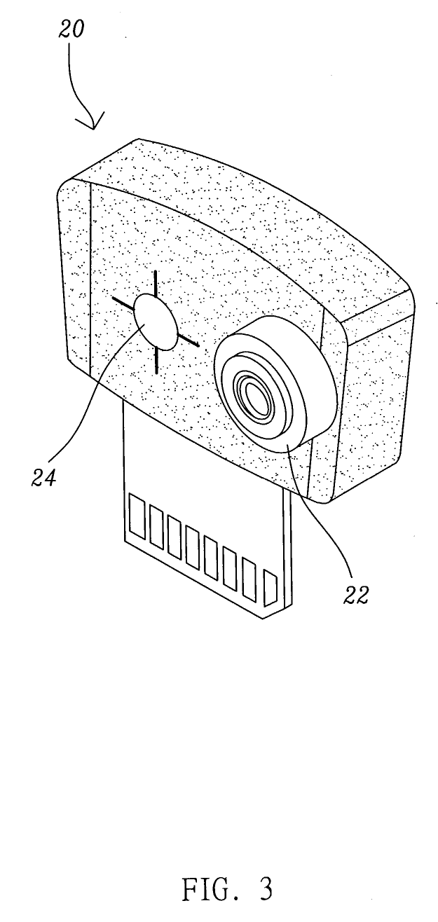

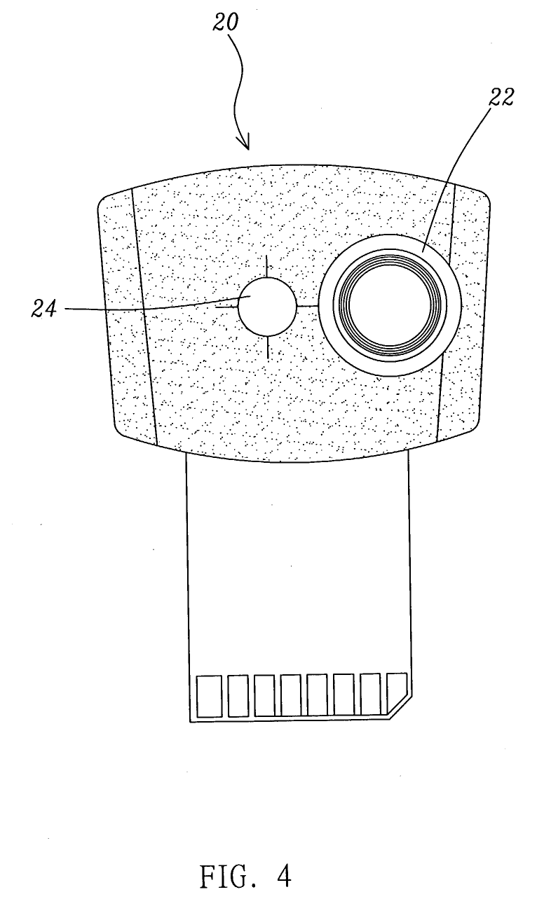

As shown in FIG. 3 and FIG. 4, a camera capable of using in the portable information appliance products includes a camera body 20 made of mat material, while a lens 22 is provided on one surface of the camera body 20; and a view-finding mirror 24 is placed on the camera body 20 and located on the same surface as the lens 22. The view-finding mirror 24 is a gloss protrusion designed to be a convex surface of a convex lens. Besides, the view-finding mirror 24 is integrally formed with the camera body 20, and the view-finding mirror 24 is processed with glossing so that the reflection made by the mirror can be applied, the view-finding mirror 24 can be viewed, and in turn the object to be photographed can be focused. Moreover, the view-finding mirror 24 is made of the convex surface of a convex lens because the wide-angle of the convex lens can enlarge the image. Therefore, when an object is being viewed, if the light can pass through the view-finding mirror 24 to be refracted by the mirror, the image of the object inside the view-finding mirror 24 can be enlarged on vision angle to facilitate adjusting the focus.

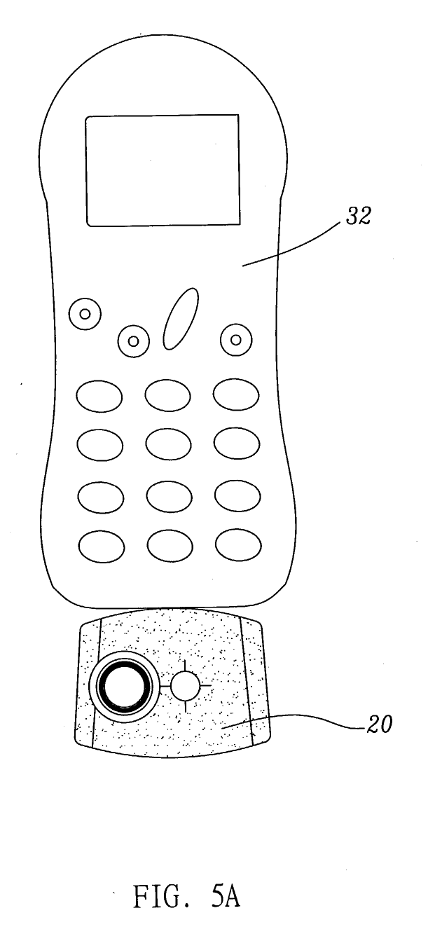

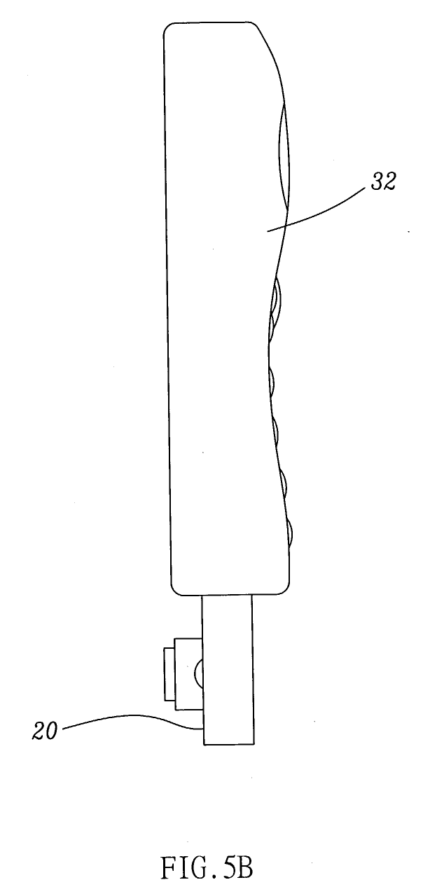

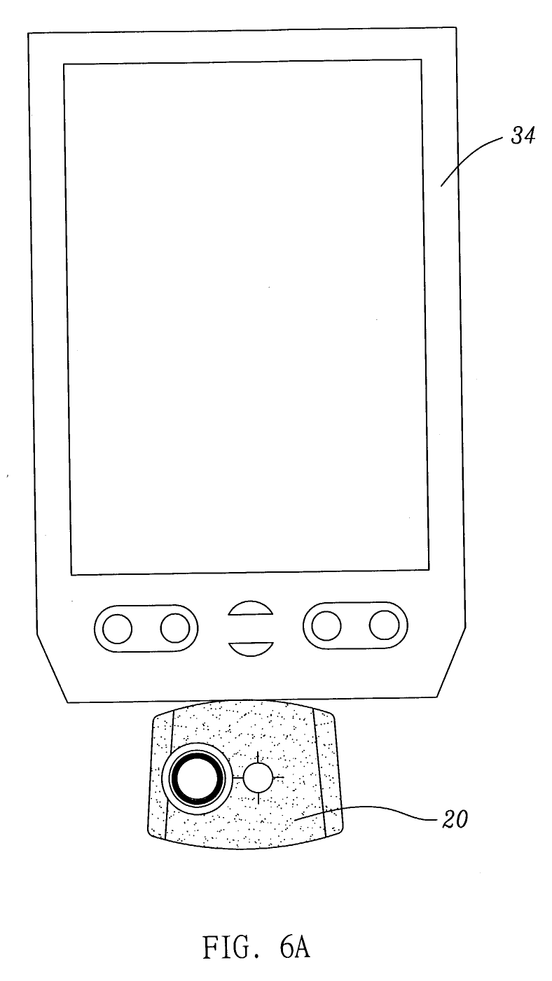

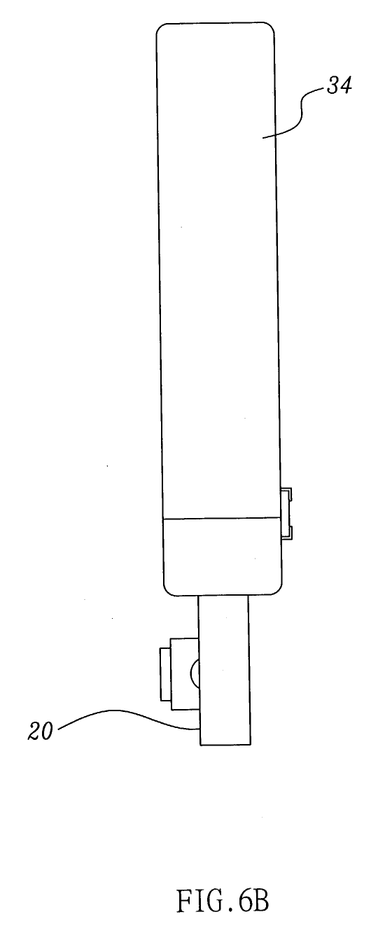

Also, an inserted card 32 is provided on the camera body 20, and through the inserted card 32, the camera body 20 can be installed on a mobile phone 34, as shown in FIG. 5A. In the same way, the camera body 20 can also be installed on a PDA 36 through the inserted card 32, as shown in FIG. 6A. In addition, the camera body 20 can be installed on other portable information appliance products through the inserted card 32 as well. Moreover, according to the user's need, the direction of the camera body 20 installed on the portable information appliance products can be altered, as shown in FIG. 5B and FIG. 6B, and the corresponding photographing procedures can be applied accordingly.

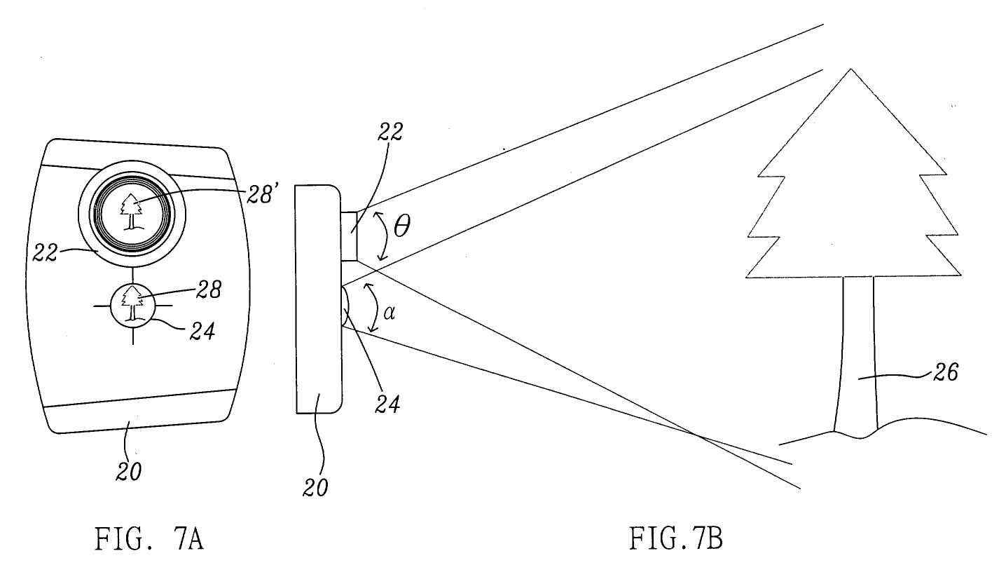

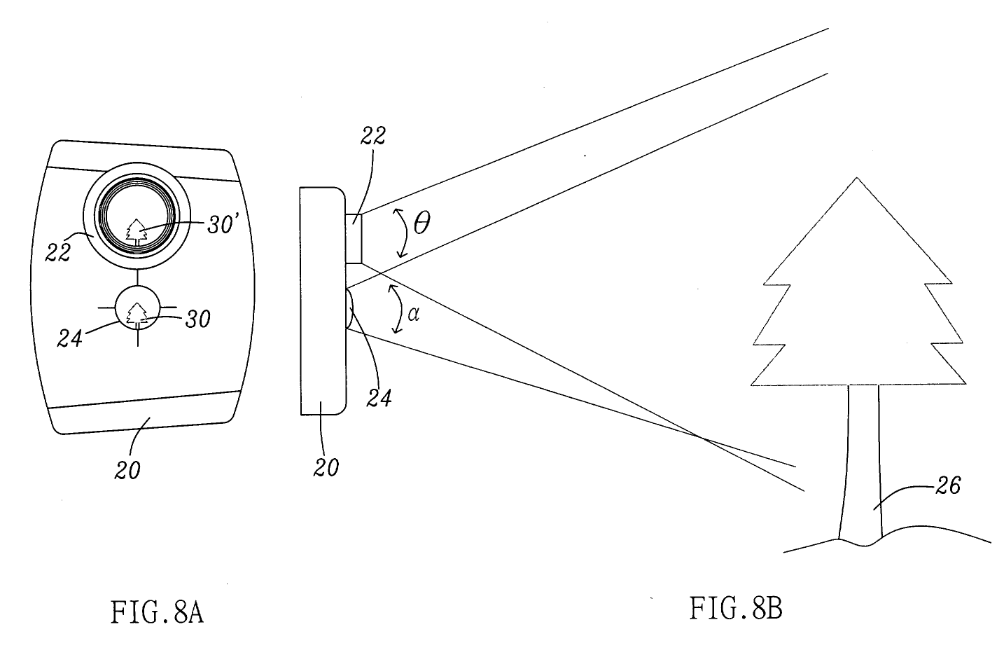

As shown in FIG. 7, the relation between the vision angle α of the view-finding mirror 24 and the vision angle θ of the lens 22 is determined as α=0.85 θ, which means that the range of the vision angle θ of the lens 22 is larger than that of the vision angle α of the view-finding mirror 24. Therefore, if the range of the vision angle α of the view-finding mirror 24 can cover the object 26 that is to be photographed, the range of the vision angle θ of the lens 22 can fully cover the object 26 as well. Hence, the full image 28 of the object 26 can be shown on the view-finding mirror 24, as shown in FIG. 7A. At this time, the full image 28 that is to be photographed can also be captured by the lens 22, and the desired picture can be taken. Conversely, as shown in FIG. 8, if the range that the vision angle α of the view-finding mirror 24 can cover is only half as large as the object 26, the range that the vision angle θ of the lens 22 can cover will only be about half as large as the object 26 also. At this time, the image 30 of the object 26 cannot be fully shown on the view-finding mirror 24, as shown in FIG. 8A. Consequently, not only the image 30 of the object 26 cannot be fully captured on the lens 22, but also the desired picture cannot be obtained, either. Hence, by examining the corresponding positions between the view-finding mirror 24 and the object 26, it can be judged whether the object 26 has been totally captured by the image 28 or 30 that is reflected on the view-finding mirror 24. If the answer is true, the object 26 can then be shown at an appropriate position in the picture.

The present invention provides a camera capable of using in the portable information appliance products. By using the view-finding mirror on the camera to support focusing on the image of the object to be photographed, the image can be easily captured as well as a self-portrait can be easily taken. Besides, the camera also has functions of being practically applicable, easy to be used, and simple to be manipulated, as well as has a stylish shape.

The specific embodiment above is only intended to illustrate the invention; it does not, however, to limit the invention to the specific embodiment. Accordingly, various modifications and changes may be made without departing from the spirit and scope of the invention as described in the following claims.

What is claimed is:

1. A camera capable of using in the portable information appliance products, including:
a camera body having a lens is provided thereon; and
a view-finding mirror, which is located on the same surface as said lens and is a gloss protrusion, for viewing the object to be photographed.

2. The camera as claimed in claim 1, wherein said camera body is made of mat material.

3. The camera as claimed in claim 1, wherein the protrusion of the view-finding mirror is designed to be a convex surface of a convex lens.

4. The camera as claimed in claim 1, wherein the relation between the vision angle α of the view-finding mirror and the vision angle θ of the lens is determined as α=0.85 θ.

5. The camera as claimed in claim 1, wherein said view-finding mirror is integrally formed with said camera body, and said view-finding mirror is processed with glossing.
